(19) United States
(12) Patent Application Publication
(10) Pub. No.: US 2019/0341657 A1
(43) Pub. Date: Nov. 7, 2019

(54) SMART-BATTERY-PROTECTION PLATE, SMART BATTERY, AND MOBILE PLATFORM

(71) Applicant: SZ DJI TECHNOLOGY CO., LTD., Shenzhen (CN)

(72) Inventors: Wentao WANG, Shenzhen (CN); Caihui ZHANG, Shenzhen (CN); Dayang ZHENG, Shenzhen (CN)

(21) Appl. No.: 16/447,923

(22) Filed: Jun. 20, 2019

Related U.S. Application Data
(63) Continuation of application No. PCT/CN2017/082291, filed on Apr. 27, 2017.

(30) Foreign Application Priority Data
Dec. 21, 2016 (CN) 201621419631.8

(51) Int. Cl. H01M 10/42; H01M 2/04; H01M 2/06; H01M 2/26

(52) U.S. Cl. CPC H01M 10/4257; H01M 2/04; H01M 2220/20; H01M 2/26; H01M 2/06

(57) ABSTRACT

A protection plate includes a circuit board including a top surface and a bottom surface opposite to the top surface, a control circuit arranged at the top surface of the circuit board and configured to control a battery core, and a solder pad arranged at the bottom surface of the circuit board and soldered with an electrode tab of the battery core.

### CROSS-REFERENCE TO RELATED APPLICATIONS

This application is a continuation of International Application No. PCT/CN2017/082291, filed on Apr. 27, 2017, which claims priority to Chinese Application No. 201621419631.8, filed on Dec. 21, 2016, the entire contents of both of which are incorporated herein by reference.

### TECHNICAL FIELD

The present disclosure relates to a smart-battery-protection plate, a smart battery using the same, and a mobile platform.

### BACKGROUND

Currently, unmanned aerial vehicles (UAVs) generally use a smart battery as the power source. However, the smart battery has a relatively low volumetric capacity that results in a shorter life time of the UAVs.

Currently, the smart battery generally includes a protection plate, an electrode-tab plate, and a battery core. The electrode-tab plate and the protection plate are connected via a connector and a power wire. After a positive-electrode tab and a negative-electrode tab of the battery core pass through through-holes of the electrode-tab plate, the positive-electrode tab and the negative-electrode tab are bent and are soldered onto the electrode-tab plate. The electrode-tab plate needs to be separately provided. Furthermore, there is a gap between the protection plate and the electrode-tab plate, which will occupy a capacity space of the smart battery, thereby reducing the volumetric capacity of the smart battery. In addition, the connecting wire and the power wire are not only increase the material costs and assembling costs, but also reduce the operating stability of the smart battery.

### SUMMARY

In accordance with the disclosure, there is provided a protection plate including a circuit board including a top surface and a bottom surface opposite to the top surface, a control circuit arranged at the top surface of the circuit board and configured to control a battery core, and a solder pad arranged at the bottom surface of the circuit board and soldered with an electrode tab of the battery core.

Also in accordance with the disclosure, there is provided a smart battery including a housing, a battery core arranged inside the housing and including an electrode tab, and a protection plate arranged inside the housing. The protection plate includes a circuit board including a top surface and a bottom surface opposite to the top surface, a control circuit arranged at the top surface of the circuit board and configured to control the battery core, and a solder pad arranged at the bottom surface of the circuit board and soldered with the electrode tab.

Also in accordance with the disclosure, there is provided a mobile platform including a vehicle body including a battery compartment, a power system, and a smart battery received inside the battery compartment and electrically connected to the power system. The smart battery includes a housing, a battery core arranged inside the housing and including an electrode tab, and a protection plate arranged inside the housing. The protection plate includes a circuit board including a top surface and a bottom surface opposite to the top surface, a control circuit arranged at the top surface of the circuit board and configured to control the battery core, and a solder pad arranged at the bottom surface of the circuit board and soldered with the electrode tab.

### BRIEF DESCRIPTION OF THE DRAWINGS

FIG. 1 is a schematic structure diagram of an unmanned aerial vehicle (UAV) according to the disclosure.

FIG. 2 is a schematic structure diagram of a circuit connection of the UAV in FIG. 1.

FIG. 3 is an exploded view of a smart battery in FIG. 1.

FIG. 4 is a schematic structure diagram of a bottom surface of a protection plate shown in FIG. 3.

FIG. 5 is a schematic cross-sectional view of the smart battery in FIG. 1.

Description of main components and reference numerals

| | |
|---|---|
| Smart battery | 100 |
| Housing | 10 |
| Housing body | 11 |
| Cover plate | 12 |
| Smart-battery-protection plate | 20 |
| Circuit board | 21 |
| Controller | 22 |
| Electronic switch | 23 |
| Solder pad | 24 |
| Power gauge | 25 |
| Battery-core unit | 30 |
| Battery core | 31 |
| Battery-core housing | 311 |
| Positive-electrode tab | 312 |
| Negative-electrode tab | 313 |
| UAV | 200 |
| Vehicle body | 201 |
| Power system | 202 |

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

As used herein, when a first component is referred to as “fixed to” a second component, it is intended that the first component may be directly attached to the second component or may be indirectly attached to the second component via another component. When a first component is referred to as “connected” to a second component, it is intended that the first component may be directly connected to the second component or may be indirectly connected to the second component via a third component between them. When a first component is referred to as “arranged” at a second component, it is intended that the first component may be directly arranged at the second component or may be indirectly arranged at the second component via a third component between them.

Unless otherwise defined, all the technical and scientific terms used herein have the same or similar meanings as generally understood by one of ordinary skill in the art. As described herein, the terms used in the specification of the present disclosure are intended to describe exemplary embodiments, instead of limiting the present disclosure. The term “and/or” used herein includes any suitable combination of one or more related items listed.

Currently, the working time of a mobile platform is relatively short. One reason is that the capacity of the battery is low, i.e., the battery life time is poor. A smart battery generally includes a protection plate, an adapter plate (or referred to as an electrode-tab plate), and a plurality of battery cores. The plurality of battery cores need to be stacked together according to the needs of a product, and positive-electrode tabs and negative-electrode tabs extending from the plurality of battery cores are soldered onto the same electrode-tab plate. The electrode-tab plate is connected to the protection plate via a connector and a power wire to form an integrating smart battery.

In a conventional smart battery, the positive-electrode tabs and the negative-electrode tabs pass through the electrode-tab plate, and then are bent to be crimped with solder pads, and then are soldered onto the solder pads. Therefore, the electrode-tab plate does not have an extra area to arrange a circuit, and hence must be connected to the protection plate via connecting wires. In addition, there is a gap between the protection plate and the electrode-tab plate, which occupies the capacity space of the smart battery and wastes the space, and hence a size of the battery core needs to be reduced and the volumetric capacity of the smart battery is reduced. Furthermore, the connecting wires and the power wires are not only increase the material costs and assembling costs, but also reduce the operating stability of the smart battery.

According to the present disclosure, a smart battery has a positive-electrode tab and a negative-electrode tab soldered onto a bottom surface of a protection plate, such that a top surface of the protection plate has an effective area to arrange a circuit. As such, an electrode-tab plate, supporting wires, or the like can be eliminated and the reliability of electrical connections can be improved. Furthermore, a mobile platform using the smart battery can have a longer continuous working time and a more stable use state. Hereinafter, the smart battery and the mobile platform having the smart battery will be described in detail below. The mobile platform can include an unmanned aerial vehicle (UAV), a driverless vehicle, or the like. The mobile platform can include a vehicle body, a power system, and the smart battery. The vehicle body can include a battery compartment configured to receive the smart battery. The smart battery can be received in the battery compartment, and the smart battery can be electrically connected to the power system and can supply power to the power system.

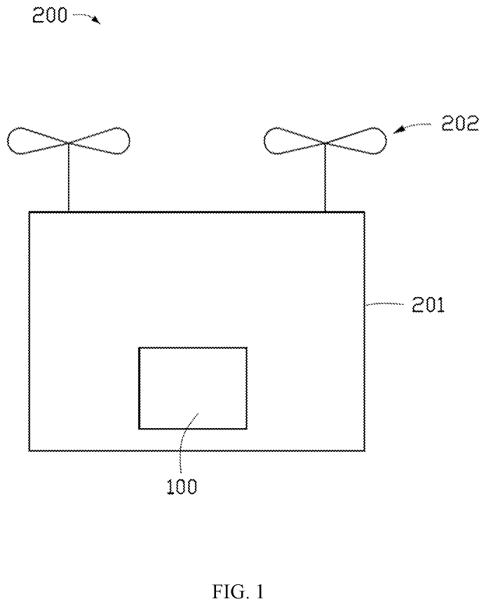

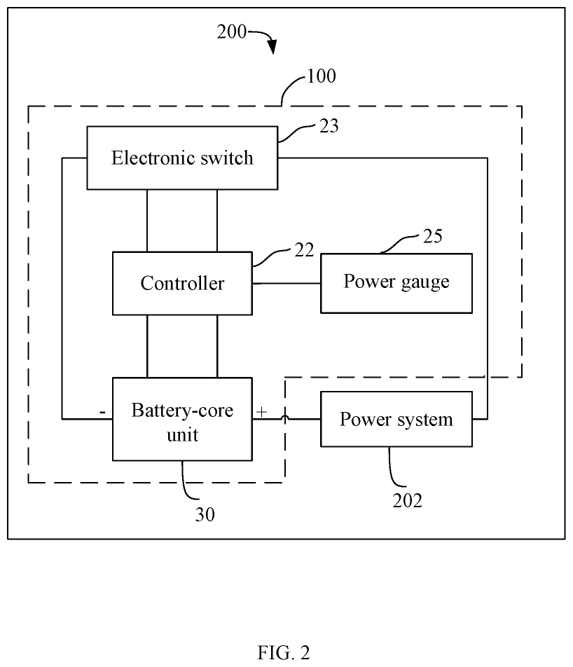

Taking the UAV as an example of the mobile platform, the UAV having the smart battery will be described in detail below. FIG. 1 is a schematic structure diagram of a UAV 200 consistent with the disclosure. FIG. 2 is a schematic structure diagram of a circuit connection of the UAV 200 consistent with the disclosure.

As shown in FIGS. 1 and 2, the UAV 200 includes a smart battery 100, a vehicle body 201, and a power system 202.

The vehicle body 201 includes a battery compartment (not shown in FIGS. 1 and 2). In some embodiments, the battery compartment can be provided at the vehicle body 201. The smart battery 100 can be arranged inside the battery compartment. The power system 202 is electrically connected to the smart battery 100 and is configured to supply a flight power for the UAV 200.

It can be appreciated that a similar battery compartment can be provided when the mobile platform is a driverless vehicle or a gimbal and the detailed description thereof is omitted here.

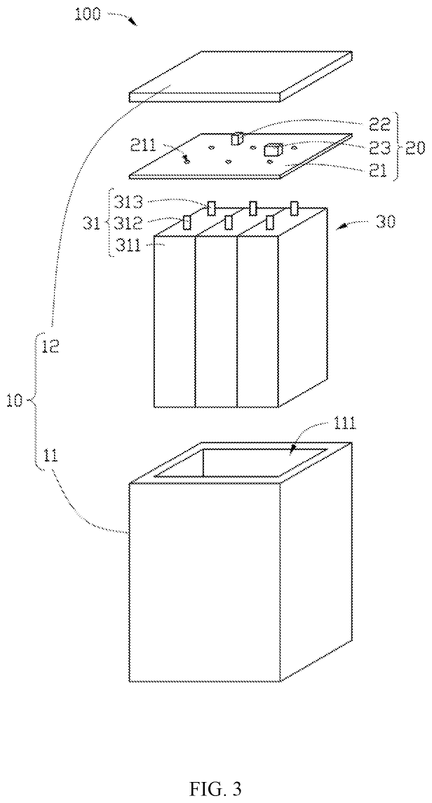

FIG. 3 is an exploded view of the smart battery 100. As shown in FIG. 3, the smart battery 100 includes a housing 10, a smart-battery-protection plate 20 (or simply referred to as a “protection plate”), and a battery-core unit 30. The housing 10 includes a receiving cavity 111. The smart-battery-protection plate 20 and the battery core 30 can be received inside the receiving cavity 111 of the housing 10.

The housing 10 includes a housing body 11 and a cover plate 12. The cover plate 12 can cover on a top of the housing body 11, and hence the cover plate 12 and the housing body 11 can be assembled to form the housing 10.

In some embodiments, the housing body 11 can be formed by assembling a plurality of components. In some other embodiments, the housing body 11 can also be a one-piece molded structure. The disclosure is not limited thereto. The housing body 11 includes the receiving cavity 111 and the top of the housing body 11 has an open structure. The receiving cavity 111 can be configured to receive the smart-battery-protection plate 20 and the battery-core unit 30. In some other embodiments, the housing body 11 can further include a heat dissipating hole (not shown In FIG. 3) configured to dissipate heat when the smart battery 100 is in use.

The cover plate 12 covers the opening structure of the housing body 11. The cover plate 12 covers the housing body 11 to close the receiving cavity 111. In some embodiments, the cover plate 12 and the housing body 11 can be interlocked with each other, for example, interlocked by a snap structure. In some other embodiments, the cover plate 12 and the housing body 11 can also be fixed through another manner, for example, gluing, connecting by fasteners, or the like. The disclosure is not limited thereto.

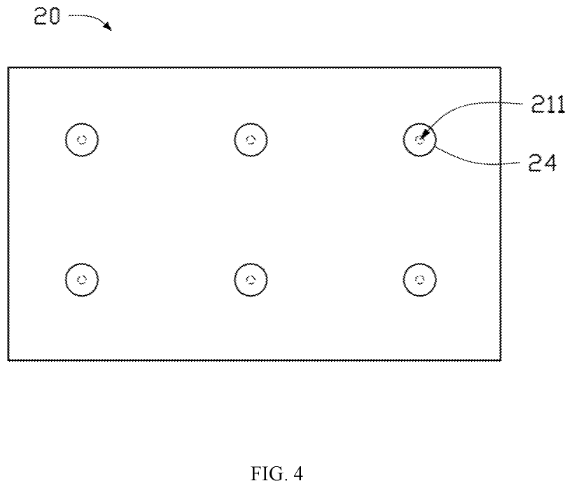

FIG. 4 is a schematic structure diagram of a bottom surface of the protection plate 20 consistent with the disclosure. As shown in FIGS. 3 and 4, the smart-battery-protection board 20 can be received in the receiving cavity 111 and is arranged near a top of the battery-core unit 30. The smart-battery-protection plate 20 includes a circuit board 21, a control circuit, and a plurality of solder pads 24. The control circuit and the plurality of solder pads 24 are arranged at the circuit board 21.

In some embodiments, the circuit board 21 can include a printed circuit board. The circuit board 21 is configured to carry and fix the control circuit and the plurality of solder pads 24. For example, the control circuit can be arranged at a top surface of the circuit board 21. The top surface refers to a surface of the circuit board 21 opposite to the battery-core unit 30. The circuit board 21 includes the plurality of solder pads 24 on a back surface of the circuit board 21. The back surface refers to a surface of the circuit board 21 facing the battery-core unit 30. In some embodiments, the circuit board 21 includes a plurality of solder holes 211 and the plurality of solder holes 211 are arranged through the circuit board 21.

Referring again to FIG. 2, the control circuit includes a controller 22, an electronic switch 23, and a power gauge 25. The controller 22 can be electrically connected to the electronic switch 23, the plurality of solder pads 24, and the power gauge 25 via the circuit board 21.

The controller 22 is arranged at the top surface of the circuit board 21. The controller 22 can be electrically connected to the electronic switch 23, the plurality of solder pads 24, and the power gauge 25. The controller 22 can control the on and off of the electronic switch 23 to control a power output or disconnection of the smart battery. For example, the controller 22 can be electrically connected to the electronic switch 23 and the plurality of solder pads 24 via the circuit board 21. The controller 22 can receive an electrical signal sent by the power gauge 25. The power gauge 25 can be configured to monitor parameters, such as power information of the smart battery 100 or the like. The controller 22 can receive monitoring information sent by the power gauge 25 to monitor a status of a current remaining power of the smart battery 100, thereby realizing various protection functions for the smart battery 100. In some embodiments, the controller 22 can include a microcontroller unit (MCU).

The electronic switch 23 is arranged at the top surface of the circuit board 21. The electronic switch 23 can be configured to control an input or output of an electric energy of the battery-core unit 30. For example, the electronic switch 23 can be controlled by the controller 22, and the controller 22 can control the electronic switch 23 to be off when the smart battery 100 is overcharged, over-discharged, short-circuited, over-temperature, under-temperature, or the like, thereby ensuring the safety of the battery. The electronic switch 23 can be on and off under the control of the controller 22. In some embodiments, the electronic switch 23 can include a Metal Oxide Semiconductor (MOS) switch.

As shown in FIG. 4, the plurality of solder pads 24 are arranged at the bottom surface of the circuit board 21. For example, the plurality of solder pads 24 are attached to the bottom surface of the circuit board 21 and are arranged in an one-to-one correspondence with the plurality of solder holes 211. For example, the plurality of solder pads 24 can be respectively attached to the bottoms of the corresponding solder holes 211. That is, the bottom of each solder hole 211 is covered by the corresponding solder pad 24 to form a structure having the covered bottom and the opened top.

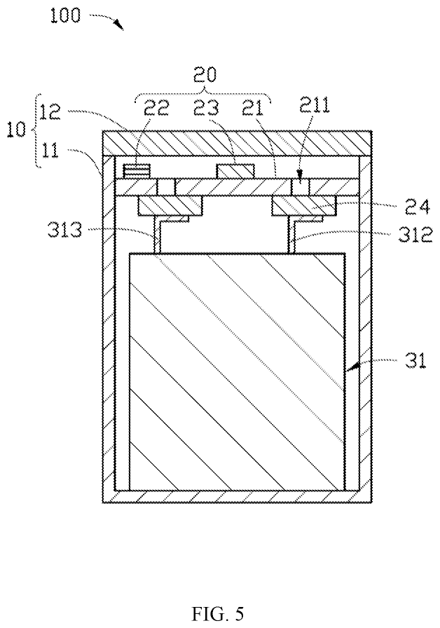

FIG. 5 is a schematic cross-sectional view of the smart battery 100 consistent with the disclosure. As shown in FIG. 5, the battery-core unit 30 includes a plurality of battery cores 31. Each battery core 31 includes a battery housing 311 (shown in FIG. 3), a positive-electrode tab 312, a negative-electrode tab 313, a positive electrode sheet (not shown in FIG. 5), a negative electrode sheet (not shown in FIG. 5), a separator (not shown in FIG. 5), and an electrolyte (not shown in FIG. 5). The battery housing 311 includes a receiving space and the positive electrode sheet, the negative electrode sheet, and the separator are received inside the receiving space of the battery housing 311. The positive-electrode tab 312 and the negative-electrode tab 313 can be collectively referred to as electrode tabs. The positive-electrode tab 312 and the negative-electrode tab 313 are partially received inside the battery housing 311. The positive-electrode tab 312 and the negative-electrode tab 313 are respectively connected to the positive electrode sheet and the negative electrode sheet and extend out of the battery housing 311. The electrolyte can be in a liquid state or a semi-solid state. The electrolyte can be also received in the battery housing 311 and can be arranged between the positive electrode sheet and the negative electrode sheet.

In some embodiments, the number of the battery cores 31 is 6 or 12. In some other embodiments, the number of the battery cores 31 can also be another number. The disclosure is not limited thereto.

The battery housing 311 can be a metal housing, such as a steel housing or an aluminum housing, or can be a housing made of a flexible material, such as an aluminum-plastic film. The disclosure is not limited thereto. The battery housing 311 includes the receiving space and the positive electrode sheet, the negative electrode sheet, the separator, the positive-electrode tab 312, and the negative-electrode tab 313 can be received inside the receiving space of the battery housing 311.

The positive electrode sheet includes a positive current collector (not shown in FIG. 5) and a positive electrode active material (not shown in FIG. 5) coated on a surface of the positive current collector. In some embodiments, the positive current collector includes an aluminum foil.

The negative electrode sheet includes a negative current collector (not shown in FIG. 5) and a negative electrode active material (not shown in FIG. 5) coated on a surface of the negative current collector. In some embodiments, the negative current collector includes a copper foil.

The separator is configured to separate the positive electrode sheet and the negative electrode sheet, thereby preventing the positive electrode sheet and the negative electrode sheet from being contact and short-circuiting.

In some embodiments, the positive electrode sheet, the separator, and the negative electrode sheet are stacked in order and are coiled. The positive-electrode tab 312 is connected to the positive electrode sheet and the negative-electrode tab 313 is connected to the negative electrode sheet.

An end of the positive-electrode tab 312 is connected to the current collector of the positive electrode sheet, and the other end of the positive-electrode tab 312 extends out of the receiving space of the battery housing 311 and is soldered onto the corresponding solder pad 24. In some embodiments, there are multiple positive-electrode tabs 312, and each positive-electrode tab 312 corresponds to a solder pad 24. For example, an end portion of an end of each positive-electrode tab 312 extending out of the battery housing 311 can be bent to contact the corresponding solder pad 24.

In this situation, each positive-electrode tab 312 is in surface contact with the corresponding solder pad 24 and is soldered to the solder hole 211 corresponding to the solder pad 24, such that the positive-electrode tab 312 and the corresponding solder pad 24 can be soldered. The soldering manner can be resistance soldering or laser soldering, and the solder pad 24 can be a resistance solder pad or a laser solder pad. The soldering can be performed from a top of the soldering hole 211 by resistance soldering or laser soldering, such that the positive-electrode tab 312 and the corresponding solder pad 24 can be soldered and fixed. In some embodiments, the positive-electrode tab 312 is soldered on the corresponding solder pad 24 and fixed on the bottom surface of the smart-battery-protection board 20, and the middle portion of the positive-electrode tab 312 is located between the battery core 31 and the circuit board 21.

In some embodiments, the fixing manners of the positive-electrode tab 312 and the solder pad 24 are not limited to resistance soldering and the laser soldering, and may also include another manner. The disclosure is not limited thereto. The positive-electrode tab 312 and the current collector of the positive electrode sheet also can be fixed by soldering. In some other embodiments, the positive-electrode tab 312 and the current collector of the positive electrode sheet can also be fixed by another manner. The disclosure is not limited thereto.

The connecting manner of the negative-electrode tab 313 is similar to the connecting manner of the positive-electrode tab 312. An end of the negative-electrode tab 313 is connected to the current collector of the negative electrode sheet, and the other end of the negative-electrode tab 313 extends out of the receiving space of the battery housing 311 and is soldered onto the corresponding solder pad 24. In some embodiments, there are multiple negative-electrode tabs 313, and each negative-electrode tab 313 corresponds to a solder pad 24. For example, an end portion of an end of each negative-electrode tab 313 extending out of the battery housing 311 can be bent to surface contact the corresponding solder pad 24. The negative electrode tab 313 and the corresponding solder pad 24 can be soldered and fixed by the solder hole 211 corresponding to the solder pad 24.

In some embodiments, each negative-electrode tab 313 is arranged corresponding to one positive-electrode tab 312, and the number of the negative-electrode tabs 313 is equal to the number of the positive-electrode tabs 312. In some embodiments, the negative electrode tab 313 and the current collector of the negative electrode sheet can also be fixedly connected by soldering. In some embodiments, the negative electrode tab 313 and the current collector of the negative electrode sheet may also be fixedly connected by another manner. The disclosure is not limited thereto.

According to the disclosure, in the smart battery, the positive-electrode tab and the negative-electrode tab can be soldered onto the bottom surface of the protection plate. Not only the battery production process and material costs can be reduced, but also the reliability and capacity of the smart battery can be improved. Furthermore, the working hours of the UAV or the driverless vehicle having the smart battery can be significantly increased, and the operational stability can be improved.

It is intended that the embodiments be considered as exemplary only and not to limit the scope of the disclosure. Those skilled in the art will be appreciated that any modification or equivalents to the disclosed embodiments are intended to be encompassed within the scope of the present disclosure.

What is claimed is:

1. A protection plate comprising:
a circuit board including:
a top surface; and
a bottom surface opposite to the top surface;
a control circuit arranged at the top surface of the circuit board and configured to control a battery core; and
a solder pad arranged at the bottom surface of the circuit board and soldered with an electrode tab of the battery core.

2. The protection plate of claim 1, wherein:
the circuit board includes a solder hole corresponding to the electrode tab, the solder hole penetrating through the circuit board; and
the electrode tab is connected to the solder pad via the solder hole.

3. The protection plate of claim 2, wherein the solder pad is arranged to cover the solder hole.

4. The protection plate of claim 2, wherein an end portion of the electrode tab is bent and in surface contact with the solder pad, and is soldered on the solder pad.

5. The protection plate of claim 2, wherein:
the control circuit includes:
an electronic switch; and
a controller electrically connected to the electronic switch and configured to control on and off of the electronic switch; and
the bottom surface of the circuit board faces the battery core.

6. The protection plate of claim 5, wherein the controller includes a microcontroller unit (MCU).

7. The protection plate of claim 5, wherein the control circuit further includes a power gauge electrically connected to the controller and configured to monitor a remaining power of the battery core.

8. The protection plate of claim 2, wherein:
the solder pad is one of a plurality of solder pads of the protection plate and the solder hole is one of a plurality of solder holes of the circuit board; and
the plurality of solder pads are arranged in a one-to-one correspondence with the plurality of solder holes.

9. The protection plate of claim 1, wherein the solder pad includes a resistance solder pad or a laser solder pad.

10. A smart battery comprising:
a housing;
a battery core arranged inside the housing and including an electrode tab; and
a protection plate arranged inside the housing and including:
a circuit board including:
a top surface; and
a bottom surface opposite to the top surface;
a control circuit arranged at the top surface of the circuit board and configured to control the battery core; and
a solder pad arranged at the bottom surface of the circuit board and soldered with the electrode tab.

11. A mobile platform comprising:
a vehicle body including a battery compartment;
a power system; and
a smart battery received inside the battery compartment and electrically connected to the power system, the smart battery including:
a housing;
a battery core arranged inside the housing and including an electrode tab; and
a protection plate arranged inside the housing and including:
a circuit board including:
a top surface; and
a bottom surface opposite to the top surface;
a control circuit arranged at the top surface of the circuit board and configured to control the battery core; and
a solder pad arranged at the bottom surface of the circuit board and soldered with the electrode tab.

12. The mobile platform of claim 11, wherein:
the housing includes:
a housing body; and
a cover plate covering the housing body, the housing body and the cover plate forming a receiving cavity; and
the protection plate and the battery core are received inside the receiving cavity.

13. The mobile platform of claim 11, wherein:
the circuit board includes a solder hole corresponding to the electrode tab, the solder hole penetrating through the circuit board; and
the electrode tab is connected to the solder pad via the solder hole.

14. The mobile platform of claim 13, wherein the solder pad is arranged to cover the solder hole.

15. The mobile platform of claim 13, wherein an end portion of the electrode tab is bent and in surface contact with the solder pad, and is soldered on the solder pad.

16. The mobile platform of claim 13, wherein:
the control circuit includes:
an electronic switch; and
a controller electrically connected to the electronic switch and configured to control on and off of the electronic switch; and
the bottom surface of the circuit board faces the battery core.

17. The mobile platform of claim 16, wherein:
the controller includes a microcontroller unit (MCU); and
the control circuit further includes a power gauge electrically connected to the controller and configured to monitor a remaining power of the smart battery.

18. The mobile platform of claim 13, wherein:
the solder pad is one of a plurality of solder pads of the protection plate and the solder hole is one of a plurality of solder holes of the circuit board; and
the plurality of solder pads are arranged in a one-to-one correspondence with the plurality of solder holes.

19. The mobile platform of claim 11, wherein the solder pad includes a resistance solder pad or a laser solder pad.

20. The mobile platform of claim 11, wherein the mobile platform includes an unmanned aerial vehicle (UAV), a gimbal, or a driverless car.
